(19) United States
(12) Patent Application Publication
(10) Pub. No.: US 2016/0210656 A1
(43) Pub. Date: Jul. 21, 2016

(54) SYSTEM FOR MARKETING TOUCHPOINT ATTRIBUTION BIAS CORRECTION

(71) Applicants: Anto Chittilappilly, Waltham, MA (US); Payman Sadegh, Alpharetta, GA (US)

(72) Inventors: Anto Chittilappilly, Waltham, MA (US); Payman Sadegh, Alpharetta, GA (US)

(21) Appl. No.: 14/969,773

(22) Filed: Dec. 15, 2015

Related U.S. Application Data
(60) Provisional application No. 62/099,070, filed on Dec. 31, 2014.

(51) Int. Cl. G06Q 30/02

(52) U.S. Cl. CPC G06Q 30/0246

(57) ABSTRACT

The present disclosure provides a detailed description of techniques used in systems, methods, and computer program products for marketing touchpoint attribution bias correction. More specifically, the herein disclosed techniques enable identifying a collection of marketing touchpoints (e.g., associated with a desired conversion) and receiving touchpoint data and/or conversion data associated with those touchpoints. The received data is used to determine contribution values for each of the respective touchpoints that indicate the probability of conversion generated by the respective touchpoints. Some contribution values can have attribution biases. Such biases are addressed by identifying a low contribution value associated with the collection of touchpoints and reducing or eliminating the low contribution value from the remaining contribution values to generate corrected contribution values for the remaining touchpoints.

### RELATED APPLICATIONS

The present application claims the benefit of priority to co-pending U.S. Patent Application Ser. No. 62/099,070, entitled “SYSTEM FOR MARKETING TOUCHPOINT ATTRIBUTION BIAS CORRECTION” (Attorney Docket No. VISQ.P0012P), filed Dec. 31, 2014, which is hereby incorporated by reference in its entirety.

### FIELD OF THE INVENTION

The disclosure relates to the field of managing Internet advertising campaigns and more particularly to techniques for calculating marketing touchpoint attribution bias corrections.

### BACKGROUND

The prevalence of Internet advertising and marketing continues to grow at a fast pace. In the earliest days of Internet advertising and marketing, a direct correlation between online clicks (e.g., on a product banner ad) and the revenue generated by those clicks (e.g., purchase of the product) could be established. An advertiser or media campaign manager might subsequently decide to spend more of the marketing budget on such banner ads with the intent to further increase revenues correlated to those clicks. An online prospect today, however, can experience a significantly higher number of exposures to a brand and/or to constituent products (e.g., touchpoints). Such interactions often occur across multiple channels (e.g., online display, online search, TV ad, radio spot, print, etc.) as the user experiences a path or journey to a conversion and/or a certain engagement state (e.g., downloading a coupon, buying the advertised product, etc.). An advertiser and/or media campaign manager desires to know the contribution of each touchpoint in transitioning the user and/or segment of users to a target engagement state (e.g., conversion). The advertiser and/or media campaign manager might use such information to allocate a marketing budget in proportion such contributions.

Rudimentary techniques for determining the contributions of marketing touchpoints (e.g., marketing touchpoint attribution) in marketing campaigns have been used. However, certain biases can be inherent in such attribution data and/or calculations. Techniques are therefore needed to identify and remove the bias errors. One source of bias is pertaining to having access to reported data records for some touchpoints (e.g., from online display impressions), yet not having reported data for other touchpoints (e.g., search engine marketing impressions). In such cases, the reported touchpoints might be attributed conversion credit comprising a bias related to the influence of the unreported touchpoints. As an example, a billboard advertisement for Product X near the entrance of a store can have a 100% correlation to all of the sales of Product X in the store (e.g., every buyer saw the billboard when entering the store), yet the buyers might have been exposed to one or more other touchpoints (e.g., online ads, TV ads, email coupons, etc.) that influenced the buyers to visit the store and/or purchase Product X. Attributing 100%/o of the conversion credit to the billboard would include a bias at least as related to the propensity to convert generated by the other influences. Specifically, the 100% correlation may not correspond to 100%/o causation. As another example, an ad for a certain website (e.g., “20% off 1-year subscription to WSJ.com”) might be attributed 100% of the credit for a conversion (e.g., subscription purchase), yet the user might have already exhibited a propensity to visit that website (e.g., he/she had previously visited WSJ.com and/or works in the financial industry, etc.). The 100% attribution to the website ad might include a bias at least as pertaining to the pre-existing propensity to visit the website.

In some cases, attribution biases due to user propensity states can occur in retargeting campaigns. For example, a user might visit a certain website (e.g., AmericanExpress.com or “AMEX”) such that a cookie indicating the visit is generated. The cookie might then be used by various advertisers to push a certain set of touchpoints (e.g., impressions for a new AMEX card offer) designed to “retarget” users who have shown an interest in AMEX. Such touchpoints might be exposed to the user on the user's journey to conversion, yet the user already showed a propensity to convert by earlier visiting the AMEX website. Since the touchpoints associated with retargeting are treated the same as other touchpoints, a relatively high contribution might be attributed to such retargeting touchpoints, introducing a bias in the attribution results.

Legacy approaches for removing such biases include an A/B testing approach. In this approach, for example, a certain “A” touchpoint (e.g., a retargeting ad for WSJ.com) is replaced with a “B” touchpoint for some portion of the overall audience. The “B” touchpoint is designed to have a creative and message (e.g., public service announcement) unrelated to the outcome anticipated by the “A” touchpoint. Such a “B” touchpoint can often be referred to as a “placebo”. Since all other factors (e.g., audience attributes, placement, publisher, frequency, etc.) remain constant, attribution bias effects related to the target “A” touchpoint can be estimated by the relative responses due to the “A” touchpoint and “B” touchpoint. While this approach can produce meaningful results, it is costly to implement. Specifically, time and money spent in developing and deploying the A/B testing content and experiments might be more costly than anticipated by the advertiser. Furthermore, the implementation of A/B testing can induce a disruption to the advertiser's marketing campaign, and can lead to a potential loss of conversions to those experiencing the “B” touchpoint. Still further, the advertiser or media campaign manager will need to wait (e.g., days to weeks) for the results to be collected and analyzed.

Techniques are therefore needed to address the problem of quickly and cost-effectively estimating and removing bias from attribution calculations. None of the aforementioned legacy approaches achieve the capabilities of the herein-disclosed techniques for marketing touchpoint attribution bias correction. Therefore, there is a need for improvements.

### SUMMARY

The present disclosure provides an improved system, method, and computer program product suited to address the aforementioned issues with legacy approaches. More specifically, the present disclosure provides a detailed description of techniques used in systems, methods, and computer program products for marketing touchpoint attribution bias correction.

A system, method, and computer program product for marketing touchpoint attribution bias correction is disclosed herein. More specifically, the herein disclosed techniques enable identifying a collection of marketing touchpoints (e.g., associated with a desired conversion) and receiving touchpoint data and/or conversion data associated with those touchpoints. The received data is used to determine contribution values for each of the respective touchpoints that indicate the probability of conversion generated by the respective touchpoints. Some contribution values can have attribution biases. Such biases are addressed by identifying a low contribution value from among the calculated contributions values and subtracting the low contribution value from the remaining contribution values to generate corrected contribution values for the remaining touchpoints.

Further details of aspects, objectives, and advantages of the disclosure are described below and in the detailed description, drawings, and claims. Both the foregoing general description of the background and the following detailed description are exemplary and explanatory, and are not intended to be limiting as to the scope of the claims.

### BRIEF DESCRIPTION OF THE DRAWINGS

FIG. 1A illustrates a scenario for marketing touchpoint attribution bias correction, according to some embodiments.

FIG. 1B depicts an environment in which embodiments of the present disclosure can operate.

FIG. 2 depicts a progression chart showing increases in a user's probability of conversion as the user progresses through engagement states.

FIG. 3A presents a touchpoint response predictive modeling technique used in systems for marketing touchpoint attribution bias correction, according to some embodiments.

FIG. 3B presents a touchpoint attribute chart showing sample attributes associated with touchpoints of a media campaign, according to some embodiments.

FIG. 3C illustrates a touchpoint attribution technique, according to some embodiments.

FIG. 4A is a contribution value chart of touchpoints, according to some embodiments.

FIG. 4B is a corrected contribution value chart of touchpoints using techniques for marketing touchpoint attribution bias correction, according to some embodiments.

FIG. 5A and FIG. 5B depict a small contribution value range scenario and a large contribution value range scenario, respectively, using techniques for marketing touchpoint attribution bias correction, according to some embodiments.

FIG. 6 depicts a subsystem for implementing marketing touchpoint attribution bias correction, according to some embodiments.

FIG. 7A depicts a touchpoint bias correction technique for performing marketing touchpoint attribution bias correction, according to some embodiments.

FIG. 7B depicts a site bias correction technique for performing site touchpoint attribution bias correction, according to some embodiments.

FIG. 8A and FIG. 8B are block diagrams of systems for marketing touchpoint attribution bias correction, according to an embodiment.

FIG. 9A and FIG. 9B depict block diagrams of computer system components suitable for implementing embodiments of the present disclosure.

### DETAILED DESCRIPTION

### Overview

The advertiser and media campaign manager today desires to learn exactly what media touchpoints contributed the most to the conversion of a prospect in order to appropriately allocate their marketing budget to foster recurrence of the most successful tactics while minimizing expenses tied to low performing tactics. To address this desire, techniques for determining the attribution of touchpoints to achieving certain marketing campaign responses (e.g., conversion) are herein disclosed. Some of such attribution techniques are largely enabled not only by the voluminous online user activity data available (e.g., cookies, pixel tags, mobile tracking, etc.), but also by various offline data available (e.g., in-store purchase records, etc.). Certain biases are inherent in the attribution data generation, and such biases can be reduced or eliminated. As an example, a retargeting ad for a certain website (e.g., “20% off 1-year subscription to WSJ.com”) might get credit for a conversion, even though the user had already had a propensity to visit that website (e.g., due to one or more other reported and/or unreported influences).

The techniques disclosed herein enable a cost-effective attribution bias correction by considering the touchpoint or touchpoints on a user's path that are determined to have the least significant (e.g., lowest attribution value) contribution to the conversion. Such a low performing touchpoint can be deemed to be inconsequential relative to the other touchpoint(s) experienced by the user(s), and the low performing touchpoint can serve as an approximation of the aforementioned “placebo”. Such a technique is often more cost effective and less disruptive than A/B testing. The contribution from the lowest performing touchpoint represents the inherent bias in the attribution data due to users having a pre-existing propensity to convert, and can be used to more fairly generate the attribution (e.g., contribution value) of other touchpoints.

### DEFINITIONS

Some of the terms used in this description are defined below for easy reference. The presented terms and their respective definitions are not rigidly restricted to these definitions—a term may be further defined by the term's use within this disclosure.
The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.
As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances.
The articles “a” and “an” as used in this application and the appended claims should generally be construed to mean “one or more” unless specified otherwise or is clear from the context to be directed to a singular form.

Reference is now made in detail to certain embodiments. The disclosed embodiments are not intended to be limiting of the claims.

### Descriptions of Exemplary Embodiments

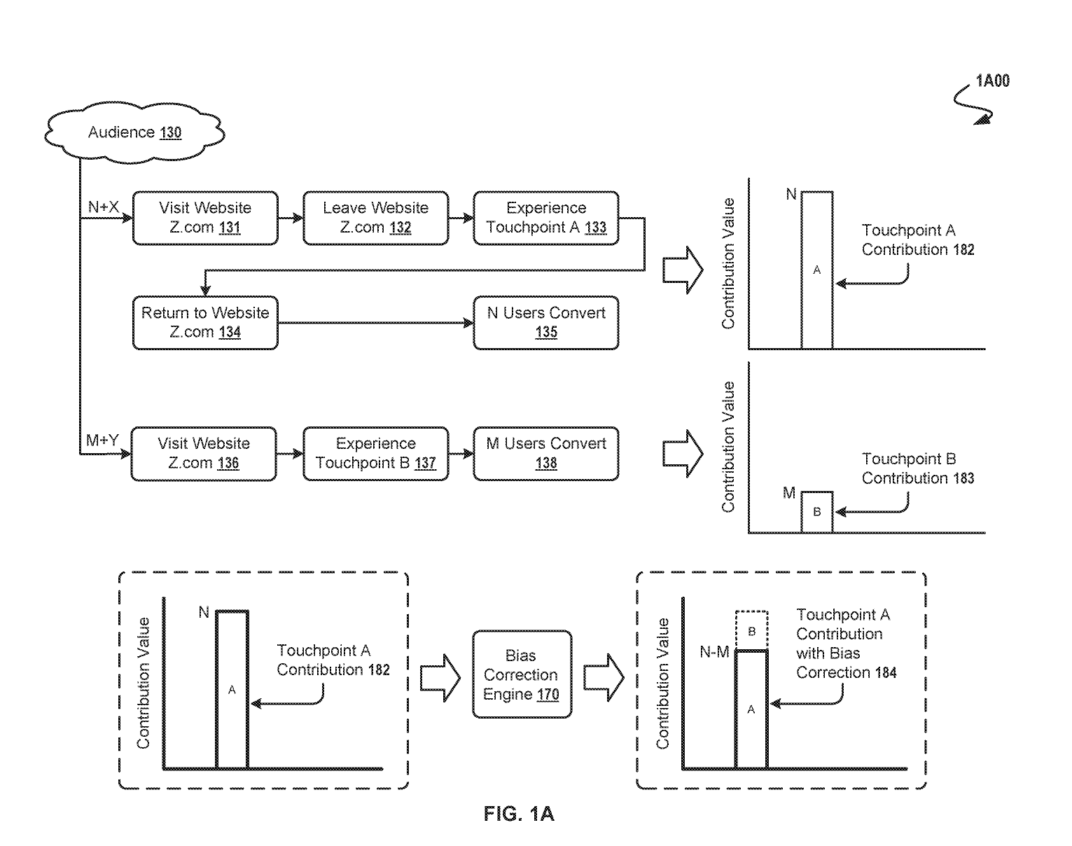

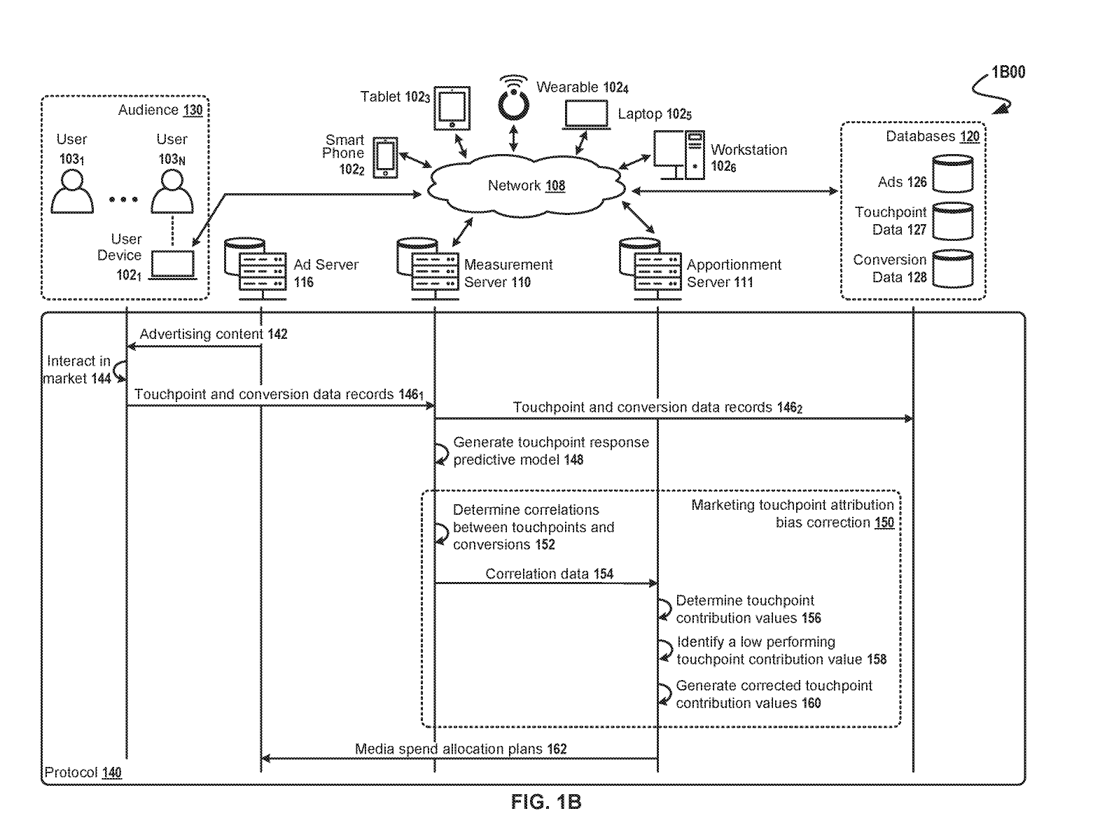

FIG. 1A illustrates a scenario 1A00 for marketing touchpoint attribution bias correction, according to some embodiments. As an option, one or more instances of scenario 1A00 or any aspect thereof may be implemented in the context of the architecture and functionality of the embodiments described herein. Also, scenario 1A00 or any aspect thereof may be implemented in any desired environment.

As shown, a portion of an audience 130 (e.g., N+X users) can visit a website Z.com (see operation 131), browse for some time, then leave the website (see operation 132). A retargeting ad provider can have knowledge (e.g., from a cookie) of the visit to Z.com and deliver an online display ad intended to influence the user to execute a particular conversion event at the website Z.com. Specifically, the retargeting ad provider might serve a touchpoint A experienced by those who have visited the website Z.com (see operation 133), redirecting them to the website Z.com (see operation 134). At the website Z.com, a certain number of users (e.g., N users) from audience 130 might convert (see operation 135). Since touchpoint A was last experienced before the conversion, touchpoint A can be attributed (at least partially) to converting the N users, and a contribution value (e.g., N) can be determined and assigned to a touchpoint A contribution 182. At the same time, and for the same website Z.com and conversion event, another portion of audience 130 (e.g., M+Y users) might directly visit the website Z.com (see operation 136). In response to the visit to Z.com (e.g., and other user attributes), the retargeting ad provider might serve a retargeting touchpoint B (see operation 137). At a later time, a certain number of users (e.g., M users) from audience 130 can convert (see operation 138). Since touchpoint B was last experienced before conversion, touchpoint B can be attributed (at least partially) to converting the M users, and a contribution value (e.g., M) can be determined and assigned to a touchpoint B contribution 183.

If some of the N users would have converted without experiencing touchpoint A (e.g., they had a prior propensity to return to the website Z.com), then there is an attribution bias present in apportioning the full credit of the N conversions to touchpoint A. The techniques disclosed herein can correct for this bias by considering a touchpoint (e.g., within a large website, group of similar smaller sites, etc.) assigned a worst performing (e.g., lowest) contribution value. Such a low performing touchpoint can be deemed to be inactive relative to other touchpoints, and serve as an approximation of the aforementioned “placebo”.

The contribution from the low performing touchpoint represents an inherent bias in the attribution data due to users having a pre-existing (e.g., prior to experiencing the one or more higher performing touchpoints) propensity to convert. In the example of scenario 1A00, touchpoint B might be such a low performing touchpoint on the website (e.g., M<<N). As shown in the flow at the bottom of scenario 1A00, the touchpoint A contribution 182 and other related data received and analyzed (e.g., touchpoint B contribution 183) can be used by a bias correction engine 170 to generate a touchpoint A contribution with bias correction 184. The touchpoint A contribution with bias correction 184 is adjusted to a lower value (e.g., N−M) to reflect the portion of the converted users (e.g., M users of N total users) that are estimated to have converted even without experiencing touchpoint A.

The foregoing example is website-centric in that it describes touchpoints as pertaining to experiences from visiting a website. Website touchpoints are merely one species of a genus of touchpoints. As used herein, touchpoints can be any sort of advertisement and/or any sort of interaction that serves to influence a specific consumer's decision to take one or more next steps in a progression from awareness to interest and then to action (e.g., to purchase an advertised product or service, to take a survey, to download a coupon, etc.) as pertaining to an underlying marketing campaign.

Further details regarding approaches to apportioning in media campaigns can be found in co-pending U.S. patent application Ser. No. 14/465,838, entitled “APPORTIONING A MEDIA CAMPAIGN CONTRIBUTION TO A MEDIA CHANNEL IN THE PRESENCE OF AUDIENCE SATURATION” (Attorney Docket No. VISQ.P0021), filed Aug. 22, 2014, which is hereby incorporated by reference in its entirety.

FIG. 1B depicts an environment 1B00 in which embodiments of the present disclosure can operate. As shown in FIG. 1B, the environment 1B00 comprises various computing systems (e.g., servers and devices) interconnected by a network 108. The network 108 can comprise any combination of a wide area network (e.g., WAN), local area network (e.g., LAN), cellular network, wireless LAN (e.g., WLAN), or any such means for enabling communication of computing systems. The network 108 can also be referred to as the Internet. More specifically, environment 1B00 comprises at least one instance of a measurement server 110, at least one instance of an apportionment server 111, at least one instance of an ad server 116, and one or more instances of databases 120 (e.g., ads 126, touchpoint data 127, conversion data 128, etc.). The servers and devices shown in environment 1B00 can represent any single computing system with dedicated hardware and software, multiple computing systems clustered together (e.g., a server farm, a host farm, etc.), a portion of shared resources on one or more computing systems (e.g., a virtual server), or any combination thereof.

The environment 1B00 further comprises at least one instance of a user device 102₁ that can represent one of a variety of other computing devices (e.g., a smart phone 102₂, a tablet 102₃, a wearable 102₄, a laptop 102₅, a workstation 102₆, etc.) having software (e.g., a browser, mobile application, etc.) and hardware (e.g., a graphics processing unit, display, monitor, etc.) capable of processing and displaying information (e.g., web page, graphical user interface, etc.) on a display. The user device 102₁ can further communicate information (e.g., web page request, user activity, electronic files, computer files, etc.) over the network 108. The user device 102₁ can be operated by a user 103_{N}. Other users (e.g., user 103₁) with or without a corresponding user device can comprise the audience 130.

As shown, the user 103₁, the user device 102₁ (e.g., operated by user 103_{N}), the measurement server 110, the apportionment server 111, the ad server 116, and the databases 120 can exhibit a set of high-level interactions (e.g., operations, messages, etc.) in a protocol 140. Specifically, the protocol can represent interactions in systems for marketing touchpoint attribution bias correction. As shown, the ad server 116 can represent an entity in an online advertising ecosystem that might facilitate the delivery of advertising content to the audience 130 (see message 142). The content can be provided to the ad server 116 by a content provider and delivered to the audience 130 through any of a plurality of channels (e.g., online display, TV, radio, print, etc.). The content can further comprise any number of touchpoints (e.g., online display ads, paid search results, etc.) configured to have various attributes so as to reach a certain portion of the audience. More particularly, for example, the ad server 116 can select a particular advertisement from a corpus of ads 126 (e.g., creative provided by an advertiser) to generate an impression (e.g., content plus the advertisement), which can serve as a touchpoint to be presented to a targeted user (e.g., user 103_{N}) on a computing device (e.g., user device 102₁). One or more users in audience 130 can also interact with such marketing campaign content (see operation 144) by, for example, taking one or more measurable actions in response to such certain touchpoints and/or other non-media effects. In some cases, the user interaction can be identified as a conversion event. Information characterizing the touchpoints and/or conversions of the audience 130 can be collected as touchpoint data records and/or conversion data records by the measurement server 110 (see message 146₁). In some cases, all or a portion of the touchpoint data records and/or the conversion data records can be stored in the databases 120 (see message 146₂). Using the touchpoint and/or conversion data, the measurement server 110 can generate a touchpoint response predictive model (see operation 148).

As highlighted in the protocol 140, a grouping 150 can represent one embodiment of certain messages and operations used for marketing touchpoint attribution bias correction according to the herein disclosed techniques. Specifically, such a grouping of interactions might commence with using the touchpoint response predictive model, the received touchpoint data, and/or the received conversion data to determine one or more correlations between certain touchpoints and certain conversion events (see operation 152). The correlation data associated with such correlations can be availed to the apportionment server 111 (see message 154) to facilitate the determination of touchpoint contribution values (see operation 156). For example, the apportionment server 111 can determine the touchpoint contribution values based on a measure of the influence a given touchpoint has on transitioning a user and/or group of users from one engagement state to another engagement state (e.g., conversion). In some cases, such contribution values can include one or more attribution biases. In such cases, the herein disclosed techniques might invoke the apportionment server 111 to identify the low performing touchpoint contribution values for a given campaign, audience, large website, collection of small website, and/or other scope of touchpoints (see operation 158). The low performing touchpoint contribution values can be used to generate a set of corrected touchpoint contribution values (see operation 160). For example, in one or more embodiments, the corrected contribution values can be generated by subtracting the low performing touchpoint contribution value from the uncorrected contribution values associated with the remaining higher performing touchpoints. In this case, the low performing touchpoint contribution values can be considered representative of the attribution bias in the collection of identified touchpoints. Further, the correction touchpoint contribution values can represent an instance of marketing touchpoint attribution with bias correction. As an example, such marketing touchpoint attribution with bias correction can facilitate the delivery (e.g., to the ad server 116 and/or other ad ecosystem partners) of one or more media spend allocation plans based on more accurate (e.g., with bias correction) information regarding touchpoint attribution (see message 162).

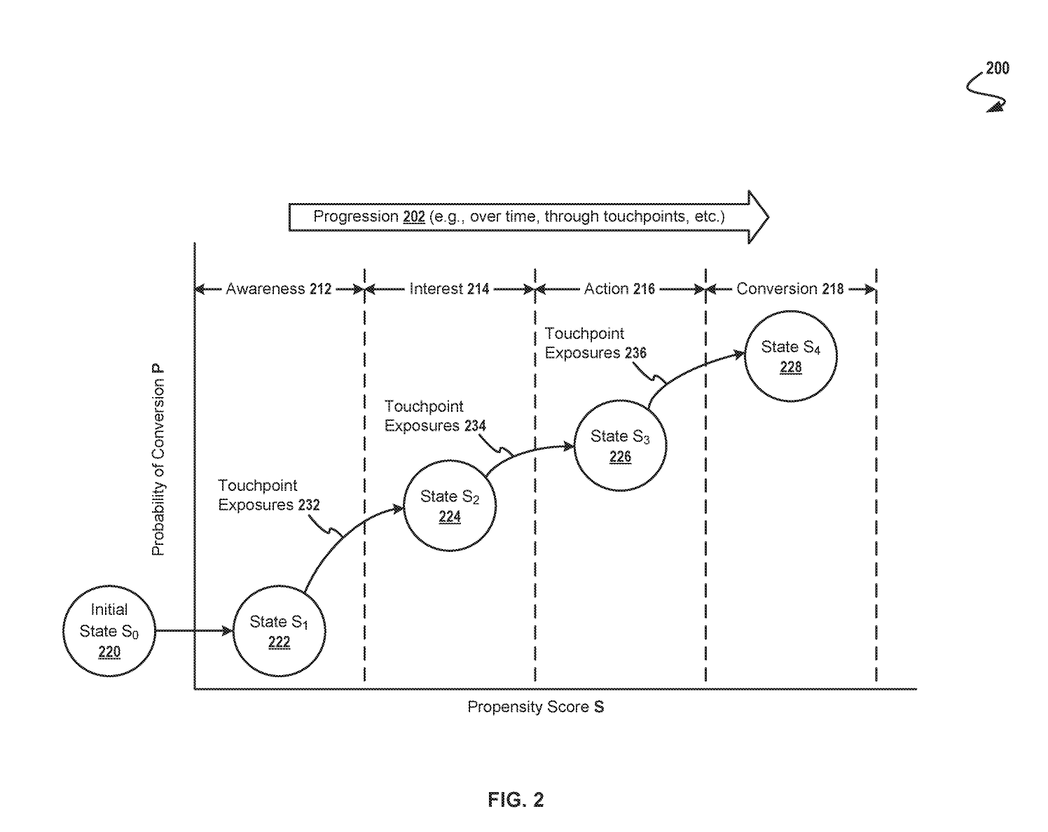

The foregoing environment serves to present advertising and marketing messages to a target audience. A particular user might experience several touchpoints, and in response to experiencing such touchpoints, the user might become more aware of the advertiser's messages (e.g., related to brand, products, etc.) and/or might take interest in the advertiser's message. With still more touchpoints, the user might be compelled to action (e.g., respond to a survey or peruse a product description), and in some cases a particular user reaches a decision point (e.g., to buy a product or subscribe to a service, or to otherwise “convert”). FIG. 2 depicts one possible progression of a user through several stages over time.

FIG. 2 depicts a progression chart 200 showing increases in a user's probability of conversion as the user progresses through engagement states. As an option, one or more instances of progression chart 200 or any aspect thereof may be implemented in the context of the architecture and functionality of the embodiments described herein. Also, the progression chart 200 or any aspect thereof may be implemented in any desired environment.

The progression chart 200 depicts a trend of a user's probability of conversion as a function of a progression 202 through states (e.g., initial state S₀ 220, state S₁ 222, state S₂ 224, state S₃ 226, and state S₄ 228). In some cases, the progression 202 through states can occur as a result of the user experiencing one or more touchpoints over time (e.g., touchpoint exposures 232, touchpoint exposures 234, touchpoint exposures 236, etc.). For example, the set of touchpoints exposed to a user in the progression 202 can be called an “engagement stack” (e.g., of touchpoints). Further, the states can represent certain levels of engagement relevant to a particular marketing campaign. As shown in the example in progression chart 200, the states correspond to user awareness 212, interest 214, action 216, and conversion 218. The probability of conversion through progression 202 can be granular. For example, more states and/or touchpoint exposures than shown in progression chart 200 are possible.

In one or more embodiments, the states of the progression 202 can be codified as having a propensity score S (as shown). A series of propensity scores need not exhibit linear behaviors of probability of conversion over any particular progression range and/or between progression ranges. For example, while the state S₃ 226 can have a linearly higher propensity score than state S₂ 224, a probability of conversion P corresponding to state S₃ 226 might be only slightly higher than a probability of conversion corresponding to state S₂ 224.

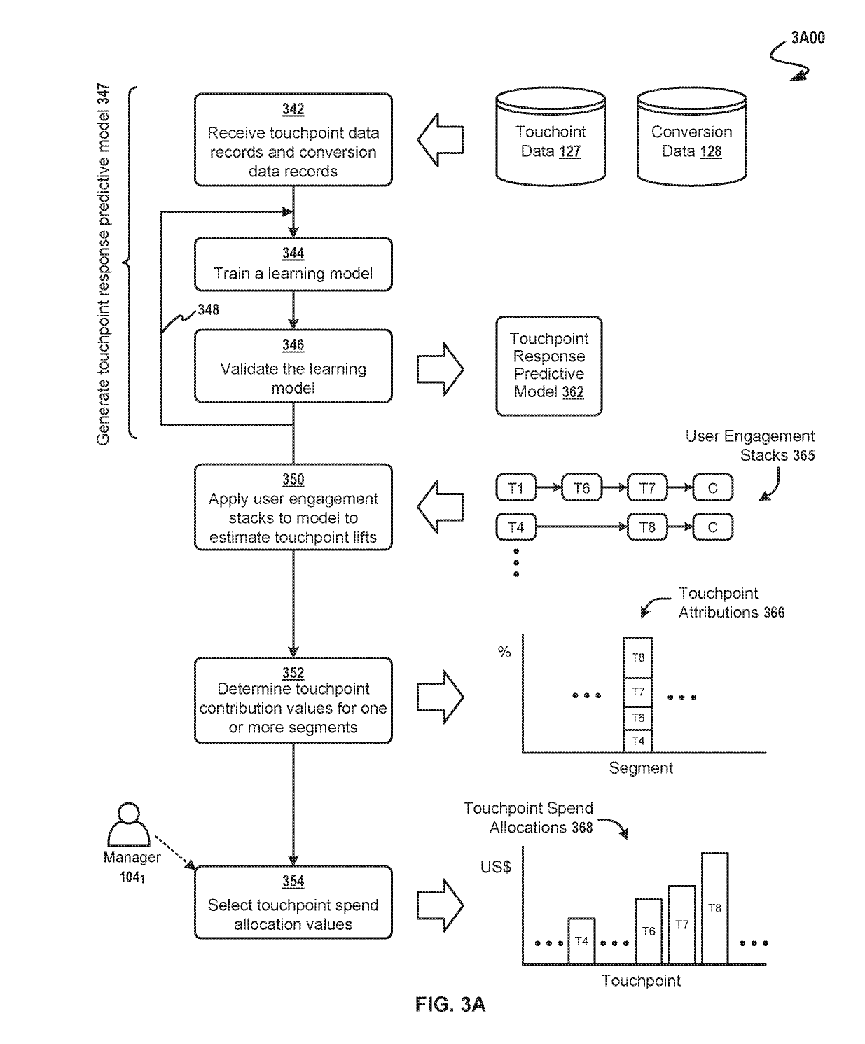

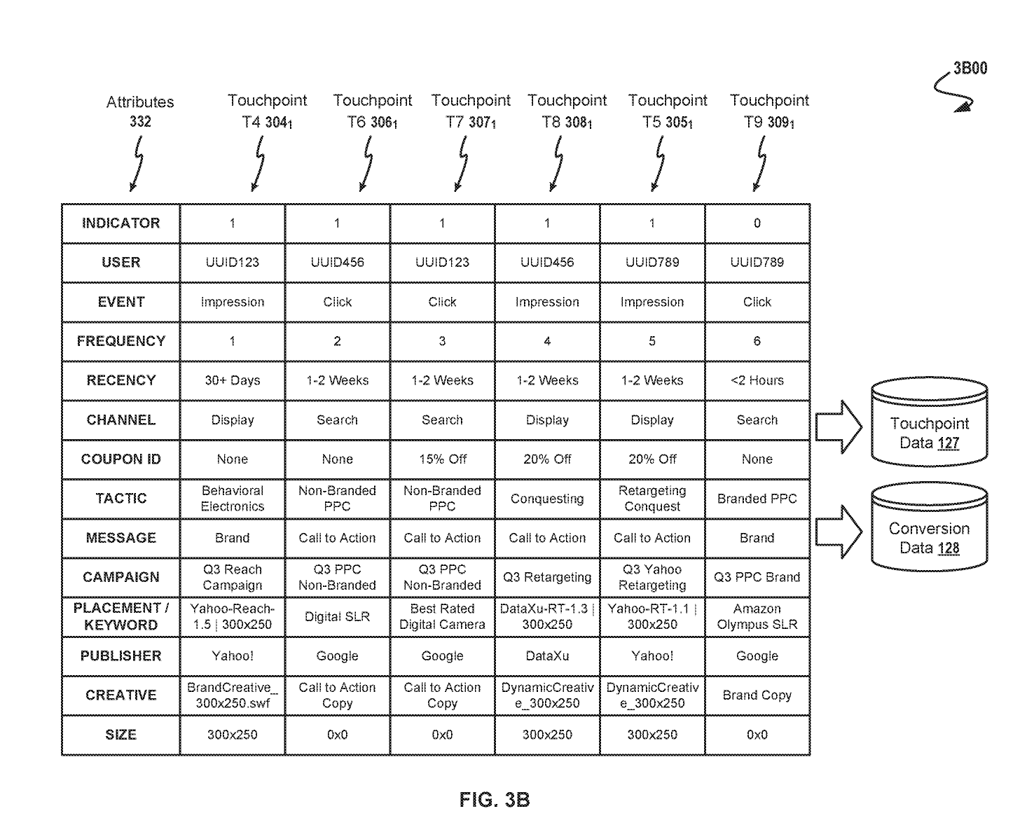

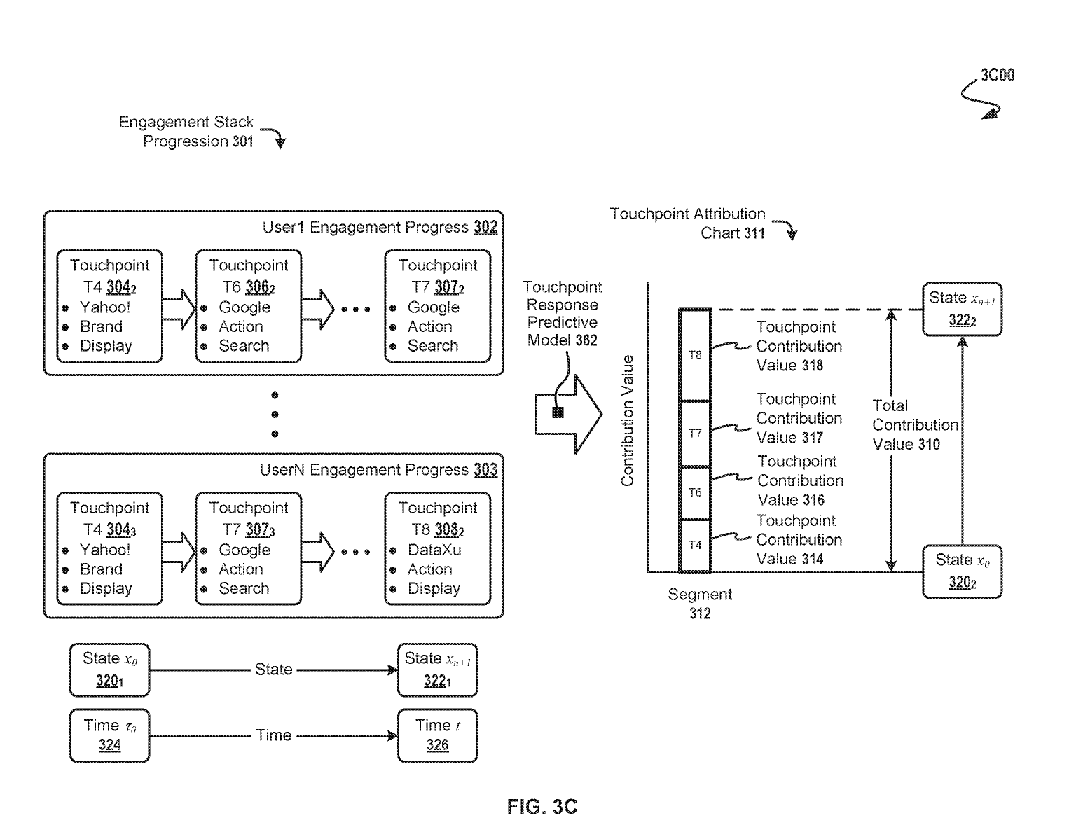

An advertiser or media campaign manager might desire to know the contribution of various touchpoints in transitioning a particular user and/or segment of users (e.g., audience) from one state to another state, and/or through the progression 202 (e.g., to conversion). In one or more embodiments, a touchpoint response predictive model can be formed to determine a fractional attribution of the contribution for each touchpoint experienced by a given segment of users in reaching a given engagement state (e.g., conversion). Such a predictive modeling technique is discussed as pertains to FIG. 3A.

FIG. 3A presents a touchpoint response predictive modeling technique 3A00 used in systems for marketing touchpoint attribution bias correction. As an option, one or more instances of touchpoint response predictive modeling technique 3A00 or any aspect thereof may be implemented in the context of the architecture and functionality of the embodiments described herein. Also, the touchpoint response predictive modeling technique 3A00 or any aspect thereof may be implemented in any desired environment.

FIG. 3A depicts process steps for generating a touchpoint response predictive model (see steps 347) to be used for determining marketing touchpoint attribution according to the herein disclosed techniques. As shown, touchpoint data records (e.g., from touchpoint data 127) and/or conversion data records (e.g., from conversion data 128) associated with one or more historical marketing campaigns and/or time periods are received by a computing device and/or system (e.g., measurement server 110) over a network (see step 342). The information associated with the touchpoint data records and/or the conversion data records can be organized in various data structures. A portion of the collected data can be used to train a learning model (see step 344). A different portion of the collected data can be used to validate the learning model (see step 346). The processes of training and/or validating can be iterated (see path 348) until the learning model behaves within target tolerances (e.g., with respect to predictive statistic metrics, descriptive statistics, significance tests, etc.). In some cases, additional historical data can be collected to further train and/or validate the learning model. When the learning model has been generated, a set of touchpoint response predictive model parameters (e.g., input variables, output variables, equations, equation coefficients, mapping relationships, limits, constraints, etc.) describing the learning model (e.g., touchpoint response predictive model 362) can be stored for access by various computing devices (e.g., measurement server 110, apportionment server 111, etc.).

Specifically, certain user engagement stacks (e.g., user engagement stacks 365) might be applied to the learning model (e.g., touchpoint response predictive model 362) to estimate the touchpoint lifts (see step 350) contributing to conversions, brand engagement events, and/or other events. In exemplary embodiments, the touchpoint response predictive model can be queried with any one or more portions of touchpoint data records, and/or portions of conversion data records. In response to the query, the touchpoint response predictive model returns predictions and/or estimations. The query parameters can be specific to a given segment of users and/or a specific one or more media channels. As such, the contribution value of a given touchpoint can be determined (see step 352) for a given segment of users and/or media channel. For example, executing step 350 and step 352 might generate a chart showing the touchpoint attributions 366 for a given segment. Specifically, a percentage contribution for a touchpoint T4, a touchpoint T6, a touchpoint T7, and a touchpoint T8 can be determined for the segment (e.g., all users, male users, weekend users, California users, etc.). In some cases, the segment might represent a given marketing channel (e.g., display, search, TV, etc.) and/or device platform (e.g., mobile, desktop, etc.). Further, a marketing manager (e.g., manager 104₁) can use the touchpoint attributions 366 to further allocate spend among the various touchpoints by selecting associated touchpoint spend allocation values (see step 354). For example, the manager 104₁ might apply an overall marketing budget (e.g., in US$) for digital media channels to the various intra-channel touchpoints. In some cases, the manager 1041 can allocate the budget according to the relative touchpoint contributions presented in the touchpoint attributions 366 to produce certain instances of touchpoint spend allocations 368 as shown. In other cases, the touchpoint spend allocations 368 can be automatically generated based on the touchpoint attributions 366. Embodiments of certain data structures used by the touchpoint response predictive modeling technique 3A00 and the herein disclosed techniques are described in FIG. 3B.

FIG. 3B presents a touchpoint attribute chart 3B00 showing sample attributes associated with touchpoints of a media campaign. As an option, one or more instances of touchpoint attribute chart 3B00 or any aspect thereof may be implemented in the context of the architecture and functionality of the embodiments described herein. Also, the touchpoint attribute chart 3B00 or any aspect thereof may be implemented in any desired environment.

As discussed herein, a touchpoint can be any occurrence where a user interacts with any aspect of a media campaign (e.g., display ad, keyword search, TV ad, etc.). Recording the various stimulation and response touchpoints associated with a marketing campaign can enable certain key performance indicators (KPIs) for the campaign to be determined. For example, touchpoint information might be captured in the touchpoint data 127, the conversion data 128, and/or other data records for use by the herein disclosed techniques. Yet, some touchpoints are more readily observed than other touchpoints. Specifically, touchpoints in non-digital media channels might be not be observable at a user level and/or an individual transaction level, such that summary and/or aggregate responses in non-digital channels are provided. In comparison, touchpoints in digital media channels can be captured real-time at a user level (e.g., using Internet technology). The attributes of such touchpoints in digital media channels can be structured as depicted in the touchpoint attribute chart 3B00.

Specifically, the touchpoint attribute chart 3B00 shows a plurality of touchpoints (e.g., touchpoint T4 304₁, touchpoint T6 306₁, touchpoint T7 307₁, touchpoint T8 308₁, touchpoint T5 305₁, and touchpoint T9 309₁) that might be collected and stored (e.g., in touchpoint data 127) for various analyses (e.g., at measurement server 110, apportionment server 111, etc.). The example dataset of touchpoint attribute chart 3B00 maps the various touchpoints with a plurality of attributes 332 associated with respective touchpoints. For example, the attribute “Channel” identifies the type of channel (e.g., “Display”, “Search”) that delivers the touchpoint, the attribute “Message” identifies the type of message (e.g., “Brand”, “Call to Action”) delivered in the touchpoint, and so on. More specifically, as indicated by the “Event” attribute, touchpoint T4 304₁ was an “Impression” presented to the user, while touchpoint T6 306₁ corresponds to an item (e.g., “Call to Action” for “Digital SLR”) the user responded to with a “Click”. Also, as represented by the “Indicator” attribute, touchpoint T4 304₁ was presented (e.g., as indicated by a “1”) in the time window specified by the “Recency” attribute (e.g., “30+Days”), while touchpoint T9 309₁ was not presented (e.g., as indicated by a “0”) in the time window specified by the “Recency” attribute (e.g., “<2 hours”). For example, the “Indicator” can be used to distinguish the touchpoints actually exposed to a user as compared to planned touchpoint stimulus. In some cases, the “Indicator” can be used to identify responses to a given touchpoint (e.g., a “1” indicates the user responded with a click, download, etc.). Further, as indicated by the “User” attribute, touchpoint T4 304ₖ was presented to a user identified as “UUID123”, while touchpoint T6 306₁ was presented to a user identified as “UUID456”. The remaining information in the touchpoint attribute chart 3B00 identifies other attribute values for the plurality of touchpoints.

A measurable relationship between one or more touchpoints and a progression through engagement and/or readiness states towards a target state is possible. In some cases, the relationship between touchpoints is deterministic (e.g., based on UUID). In other cases, the relationship between touchpoints can be probabilistic (e.g., a likelihood that two or more touchpoints are related). Such a collection of touchpoints contributing to reaching the target state (e.g., conversion, brand engagement, etc.) can be called an engagement stack. For a given marketing campaign, one or more touchpoints can be identified as being associated with the target state and/or target response (e.g., conversion event, engagement event, etc.) for the campaign. The touchpoint data (e.g., touchpoint attributes) characterizing such target responses can be stored in the conversion data 128. In other cases, the target response might be associated with one or more user interactions (e.g., in-store purchase) not captured in the touchpoint data 127. Such interactions can also be stored in the conversion data 128 to facilitate touchpoint attribution according to the herein disclosed techniques. Indeed, such target response data and associated engagements stacks can be applied to the foregoing touchpoint response predictive modeling technique 3A00 to determine the contribution values of touchpoints (e.g., touchpoint attributions 366) associated with certain desired responses, such as conversion events, brand engagement events, and/or other events. When analyzing the impact of touchpoints on a user's engagement progression and possible execution of the target response event, a time-based progression view of the touchpoints and a contribution value of the touchpoints (e.g., touchpoint attribution) can be considered as earlier discussed in FIG. 2 and further discussed in FIG. 3C.

FIG. 3C illustrates a touchpoint attribution technique 3C00. As an option, one or more instances of touchpoint attribution technique 3C00 or any aspect thereof may be implemented in the context of the architecture and functionality of the embodiments described herein. Also, the touchpoint attribution technique 3C00 or any aspect thereof may be implemented in any desired environment.

The touchpoint attribution technique 3C00 illustrates an engagement stack progression 301 that is transformed by a touchpoint response predictive model 362 to a touchpoint attribution chart 311. Specifically, the engagement stack progression 301 depicts a progression of touchpoints experienced by one or more users. More specifically, a User1 engagement progress 302 and a UserN engagement progress 303 are shown as representative of a given audience (e.g., comprising User1 to UserN). The User1 engagement progress 302 and the UserN engagement progress 303 represent the user's progress from a state x₀ 320₁ to a state xₙ₊₁ 322₁ over a time τ₀ 324 to a time t 326. For example, the state x₀ 320₁ can represent an initial user engagement state (e.g., no engagement) and the state xₙ₊₁ 322ₖ can represent a final user engagement state (e.g., conversion, brand engagement event, etc.). Further, the time τ₀ 324 to the time t 326 can represent a measurement time window for performing touchpoint attribution analyses. As shown in User1 engagement progress 302, User1 might experience a touchpoint T4 304₂ comprising a branding display creative published by Yahoo!. At some later moment, User1 might experience a touchpoint T6 306₂ comprising Google search results (e.g., search keyword “Digital SLR”) prompting a call to action. At yet another moment later in time, User1 might experience a touchpoint T7 307₂ comprising Google search results (e.g., search keyword “Best Rated Digital Camera”) also prompting a call to action. Also as shown in UserN engagement progress 303, UserN might experience a touchpoint T4 304₃ having the same attributes as touchpoint T4 304₂. At some later moment, UserN might experience a touchpoint T7 307₃ having the same attributes as touchpoint T7 307₂. At yet another moment later in time, UserN might experience a touchpoint T8 308₂ comprising a call-to-action display creative published by DataXu. Any number of timestamped occurrences of these touchpoints and/or additional information pertaining to the touchpoints and/or user responses to the touchpoints (e.g., captured in attributes 332), can be received over the network in real time for use in generating the touchpoint response predictive model 362 and/or generating the touchpoint attribution chart 311.

Specifically, the touchpoint attribution chart 311 shows the touchpoint contribution values (e.g., touchpoint contribution value 314, touchpoint contribution value 316, touchpoint contribution value 317, and touchpoint contribution value 318) of all instances of the respective touchpoints (e.g., touchpoint T4, touchpoint T6, touchpoint T7, and touchpoint T8, respectively) aggregated over a segment 312. In some cases, the segment 312 might comprise a certain group of users (e.g., an audience of N users, all male users age 18-25, etc.). In other cases, the segment 312 might be associated with a certain media channel (e.g., display, search, radio, print, email, etc.) and/or delivery platform (e.g., desktop, mobile, etc.). The overall contribution value of the touchpoints pertaining to the segment 312 is defined by a total contribution value 310. Various techniques (e.g., the touchpoint response predictive modeling technique 3A00) can determine the contribution value from the available touchpoint data. As shown, the contribution values indicate a measure of the influence (e.g., lift, contribution, conversion credit, etc.) attributed to a respective touchpoint in transitioning a user in the segment 312 from state x₀ 320₂ to state xₙ₊₁ 322₂.

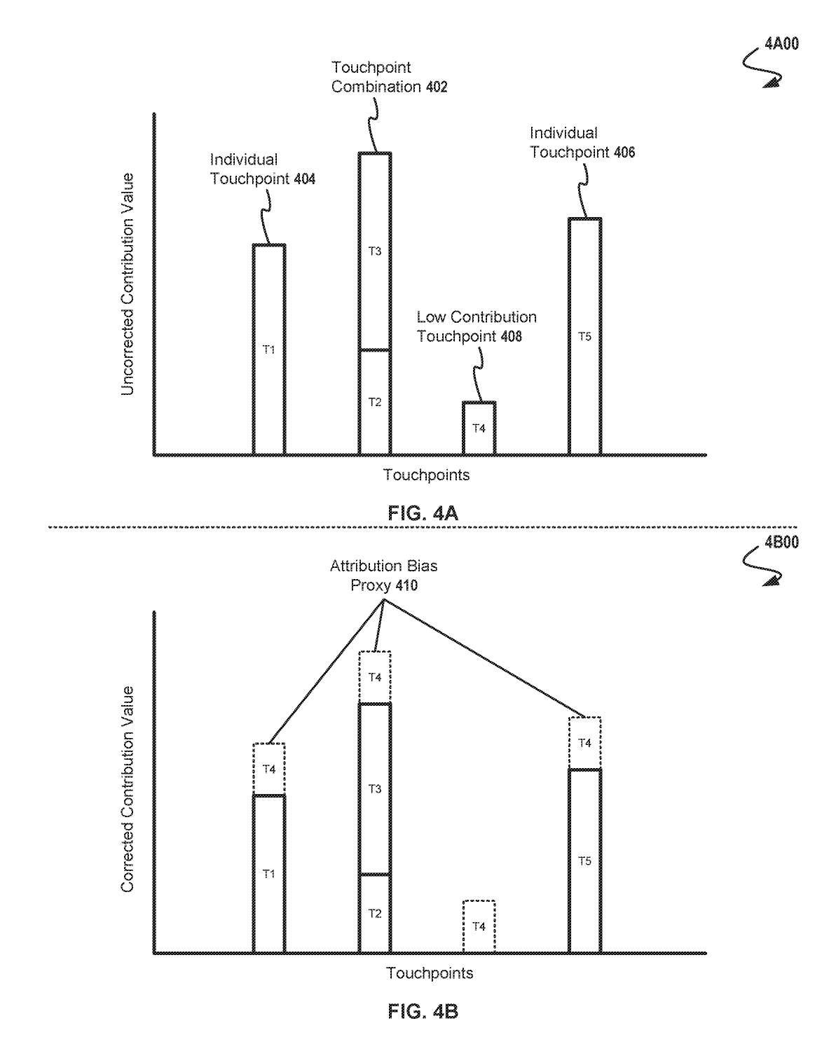

Contribution value charts such as the touchpoint attribution chart 311 can be used to illustrate the herein-disclosed techniques for marketing touchpoint attribution bias correction, as shown in FIG. 4A and FIG. 4B.

FIG. 4A is a contribution value chart 4A00. The contribution value chart 4A00 shows the relative uncorrected contribution values of various touchpoints (e.g., touchpoint T1, touchpoint T2, touchpoint T3, touchpoint T4, and touchpoint T5) and a combination of touchpoints (e.g., touchpoint T2 and touchpoint T3) for a given site and/or marketing campaign. In some embodiments, a “site” can be defined as a large website or a collection of smaller websites serving a particular segment, audience and/or group of audiences. More specifically, contribution value chart 4A00 depicts an individual touchpoint 404 (see touchpoint T1), a touchpoint combination 402 (e.g., comprising touchpoint T2 and touchpoint T3), and another instance of an individual touchpoint 406 (see T5).

Further shown is a low contribution touchpoint 408 (see touchpoint T4). The low contribution touchpoint 408 is the touchpoint from the touchpoints comprising an engagement stack determined to have the lowest contribution value. As previously mentioned, an attribution bias might be present in uncorrected contribution values (e.g., the contribution value for individual touchpoint 404, the contribution value for individual touchpoint 406, and the touchpoint combination contribution value for touchpoint combination 402). The herein disclosed techniques can correct for such biases by removing the contribution associated with the lowest performing touchpoint (e.g., low contribution touchpoint 408) from the contribution values of the remaining touchpoints within an engagement stack. Such a bias correction is illustrated in FIG. 4B.

FIG. 4B is a corrected contribution value chart 4B00 of touchpoints using techniques for marketing touchpoint attribution bias correction. As an option, one or more instances of corrected contribution value chart 4B00 or any aspect thereof may be implemented in the context of the architecture and functionality of the embodiments described herein. Also, the corrected contribution value chart 4B00 or any aspect thereof may be implemented in any desired environment.

Specifically, the corrected contribution value chart 4B00 shows the corrected contribution values of the individual touchpoint 404, the individual touchpoint 406, and the touchpoint combination 402 of FIG. 4A. More specifically, according to one or more embodiments, an attribution bias proxy 410 is determined to be equal to the contribution value of the low contribution touchpoint 408 (see touchpoint T4). As shown, in reference to FIG. 4A, the contribution values of the remaining touchpoints in the engagement stack are corrected (e.g., decreased) by the contribution value of the low contribution touchpoint 408 to yield respective corrected contribution values (e.g., a corrected contribution value for individual touchpoint 404, a corrected contribution value for individual touchpoint 406, and a corrected touchpoint combination contribution value for touchpoint combination 402). One or more system components as discussed herein can generate one or more touchpoint combination contribution values by combining two or more contribution values.

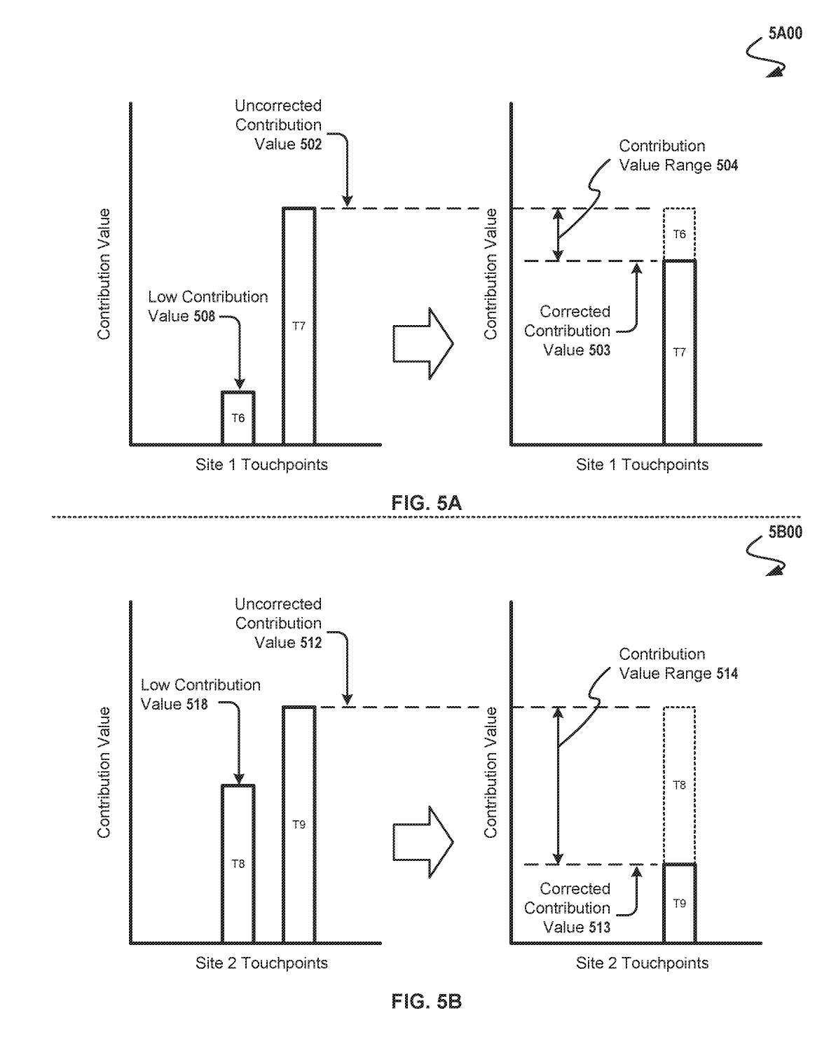

In some cases, the corrected contribution value can account for a portion of the uncorrected contribution value (e.g., the bias) that should not have been attributed to the respective touchpoints within an engagement stack. The accuracy of the correction can depend on the relative contribution values of the respective touchpoints and/or engagement stacks, as is further described in FIG. 5A and FIG. 5B.

FIG. 5A and FIG. 5B depict a small contribution value range scenario 5A00 and a large contribution value range scenario 5B00, respectively, using techniques for marketing touchpoint attribution bias correction. As an option, one or more instances of small contribution value range scenario 5A00 and large contribution value range scenario 5B00 or any aspect thereof may be implemented in the context of the architecture and functionality of the embodiments described herein. Also, the small contribution value range scenario 5A00 and the large contribution value range scenario 5B00 or any aspect thereof may be implemented in any desired environment.

Specifically, the small contribution value range scenario 5A00 illustrates a case (e.g., for “Site 1”) exhibiting an uncorrected contribution value 502 of a touchpoint (see touchpoint T7) that is substantially greater (e.g., greater than 5 times) than a low contribution value 508 of a lowest performing touchpoint (see touchpoint T6). In this case, a bias correction according to the herein-disclosed techniques can generate a corrected contribution value 503 that yields a contribution value range 504 as shown. The contribution value range 504 can represent an estimate of the range that comprises the true contribution (e.g., attribution) of the respective touchpoint.

In the case of the large contribution value range scenario 5B00 of FIG. 5B, the site (e.g., “Site 2”) is determined to have an uncorrected contribution value 512 of a touchpoint (see touchpoint T9) that is relatively a similar size (e.g., less than 2 times) of a low contribution value 518 of a low performing touchpoint (see touchpoint T8). In this case, a bias correction according to the herein-disclosed techniques can generate a corrected contribution value 513 that yields a contribution value range 514 as shown. The contribution value range 514 can represent an estimate of the range that comprises the true contribution (e.g., attribution) of the respective touchpoint.

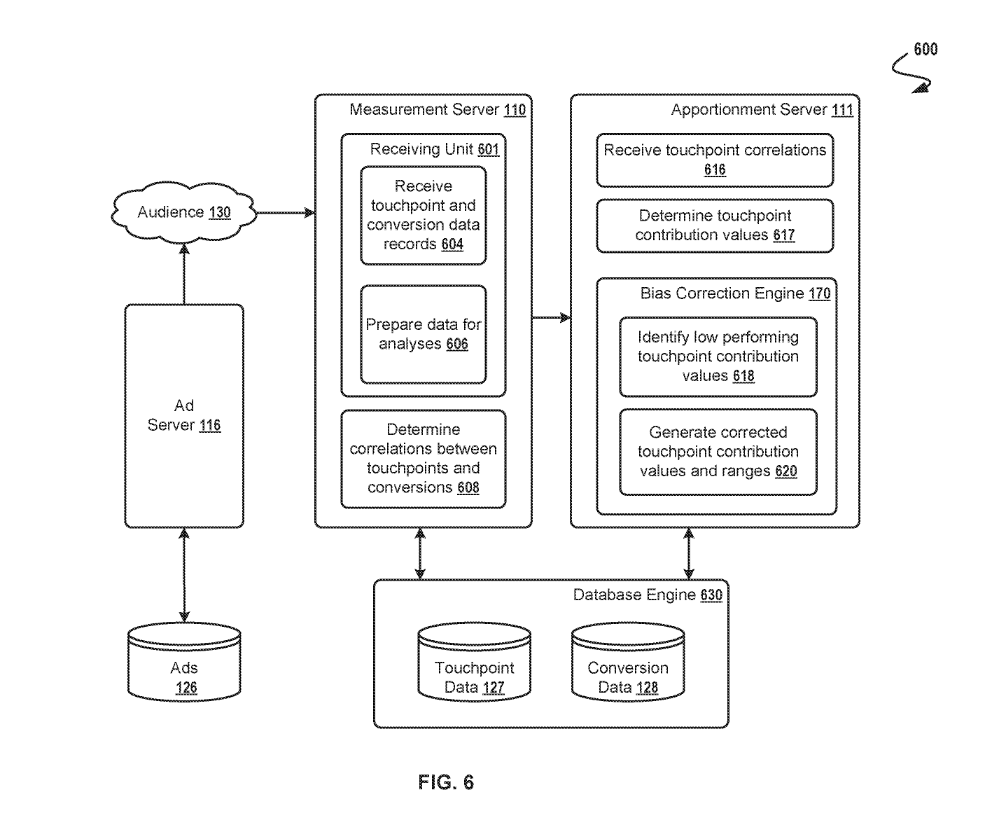

While an uncorrected contribution value can reflect an attribution that is inflated (e.g., due to attribution bias), a corrected contribution value when all touchpoints on a site are performing near the same level (e.g., in the case depicted in FIG. 5B) can reflect an attribution that is more fair. The advertiser and/or media campaign manager might require a system to determine the aforementioned touchpoint contribution values (e.g., perform touchpoint attribution), contribution value ranges, and other attribution bias correction metrics to make decisions regarding their advertising, marketing, and/or media strategies. Such a system is presented in FIG. 6.

FIG. 6 depicts a subsystem 600 for implementing marketing touchpoint attribution bias correction. As an option, one or more instances of subsystem 600 or any aspect thereof may be implemented in the context of the architecture and functionality of the embodiments described herein. Also, the subsystem 600 or any aspect thereof may be implemented in any desired environment.

A database of touchpoint data (e.g., touchpoint data 127) and a database of conversion data (e.g., conversion data 128) can be analyzed by a computing node (e.g., an instance of the measurement server 110) to perform measurements such as determining conversion credit attributable to a given touchpoint and/or set of touchpoints. As shown, a receiving unit 601 in the measurement server 110 can receive touchpoint data records and/or conversion data records (see operation 604). For example, the touchpoint data records and/or conversion data records can be earlier stored in the touchpoint data 127 and/or conversion data 128, respectively, and accessed by the measurement server 110. In other cases, the touchpoint data records and/or conversion data records (e.g., corresponding to ads 126 served by an instance of ad server 116) can be received in real time from the audience 130 over a network (e.g., the Internet). Such data can further be prepared for various analyses (see operation 606). In one or more embodiments, data preparation can include grouping of touchpoints according to various attributes (e.g., common touchpoint attributes, common desired response, common audience demographics, etc.). The prepared data can then be used to determine a set of correlations between the touchpoints and the conversions (see operation 608). In one or more embodiments, such correlations can be determined by a touchpoint response predictive model.

In the context of a media campaign, subsystem 600 can further serve to determine touchpoint attribution with bias correction. As shown, an instance of the apportionment server 111 can receive the set of touchpoint-conversion correlations from the measurement server 110 (see operation 616). The apportionment server 111 can then determine the touchpoint contribution values (see operations 617). In one or more embodiments, the apportionment server 111 can determine the touchpoint contribution values for the engagement stacks associated with a certain segment of users (e.g., audience). A bias correction engine 170 can then identify the respective low performing touchpoint contribution values for one or more sites and/or groups of sites (see operation 618). The respective low performing touchpoint contribution values can be used to generate corrected touchpoint contribution values and ranges for the remaining touchpoints and/or engagement stacks at each site and/or groups of sites (see operation 620).

The subsystem 600 presents merely one partitioning. The specific example shown where a measurement server 110 comprises a receiving unit 601 and where an apportionment server 111 comprises a bias correction engine 170 is purely exemplary, and other partitioning choices are reasonable. In some cases, the partitioning may be defined in part by the volume of empirical data and throughput of performing analyses. In some cases a database engine 630 can serve to perform certain operations (e.g., within, or in conjunction with, a database engine query).

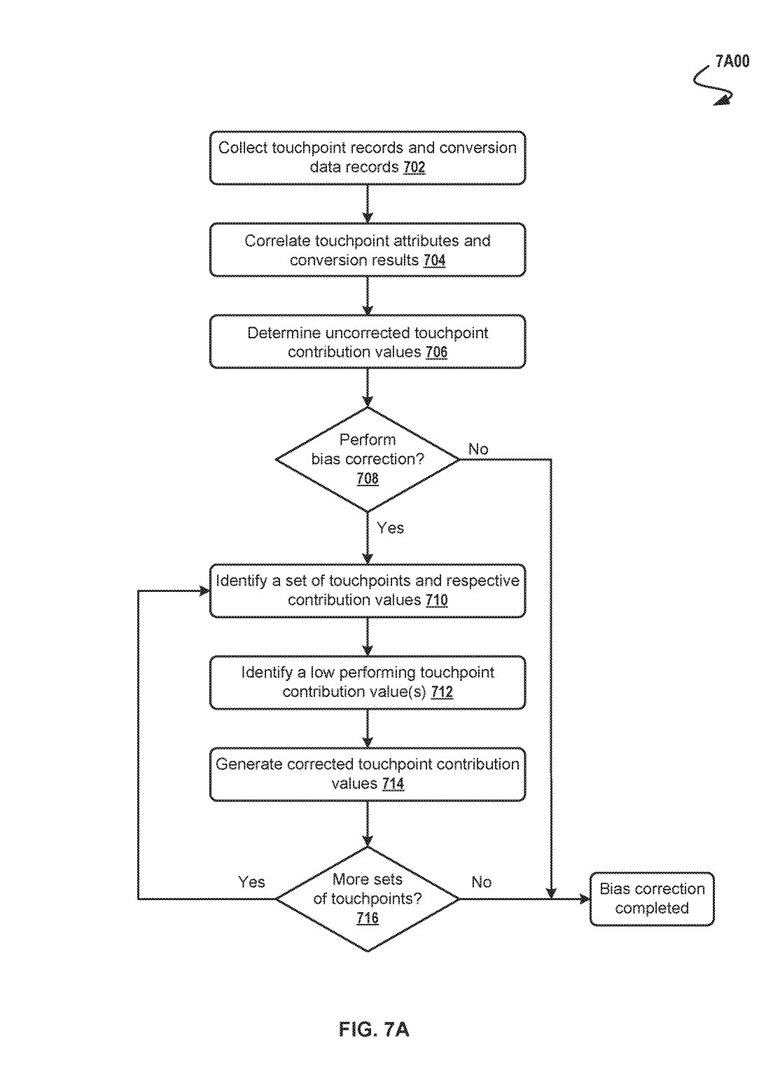

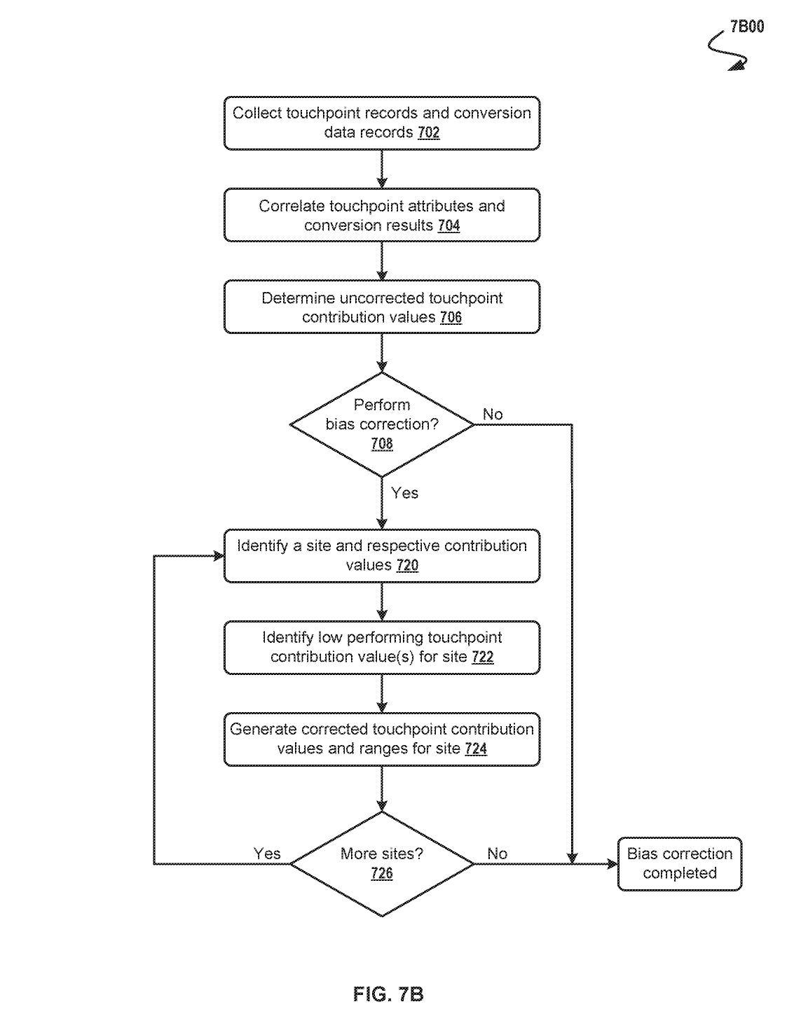

FIG. 7A depicts a touchpoint bias correction technique 7A00 for performing marketing touchpoint attribution bias correction. As an option, one or more instances of touchpoint bias correction technique 7A00 or any aspect thereof may be implemented in the context of the architecture and functionality of the embodiments described herein. Also, the touchpoint bias correction technique 7A00 or any aspect thereof may be implemented in any desired environment.

As shown, touchpoint data records and/or conversion data records can be collected (see operation 702). The collected data can be analyzed to correlate touchpoint attributes and conversion results (see operation 704). Using the correlation data and other information, uncorrected touchpoint contribution values can be determined (see operation 706). A decision 708 can determine if a bias correction is to be performed. If a bias correction is to be performed, a collection of touchpoints (e.g., comprising the engagement stacks of a segment of users) and associated contribution values can be identified (see operation 710). The collection of touchpoints can be analyzed (e.g., compared) to identify the low or lowest performing touchpoint contribution value(s) from the selected set of touchpoints (see operation 712). Corrected contribution values and ranges for the collection of touchpoints can then be generated (see operation 714). In one or more embodiments, a corrected contribution value can be generated by subtracting the low performing touchpoint contribution value from the uncorrected contribution values associated with the remaining touchpoints. A decision 716 determines if more touchpoints and/or engagement stacks are to be identified for bias correction. If so, the process returns to operation 710 and continues until all touchpoints and/or engagement stacks to be considered have been processed.

In the touchpoint bias correction technique 7A00 and/or many of the foregoing examples, an attribution bias can be represented by the contribution value of a particular touchpoint (e.g., impression, placement, etc.) associated with a particular segment, audience, and/or group of audiences across multiple sites. In some cases, an attribution bias might be represented by the contribution value of a touchpoint within a given site (e.g., large website, collection of smaller websites, etc.) serving a particular segment, audience and/or group of audiences. One embodiment of a bias correction technique for such a site is discussed as follows.

FIG. 7B depicts a site bias correction technique 7B00 for performing site touchpoint attribution bias correction. As an option, one or more instances of site bias correction technique 7B00 or any aspect thereof may be implemented in the context of the architecture and functionality of the embodiments described herein. Also, the site bias correction technique 7B00 or any aspect thereof may be implemented in any desired environment.

In some cases, an attribution bias might exist within a “site” such as a large website and/or collection of smaller websites. The site bias correction technique 7B00 depict certain steps for bias correction for such sites. Specifically, the site bias correction technique 7B00 can commence with collecting one or more touchpoint data records and/or conversion data records (see operation 702). The collected data can be analyzed to correlate touchpoint attributes and conversion results (see operation 704). Using the correlation data and other information, uncorrected touchpoint contribution values can be determined (see operation 706). A decision 708 can determine if a bias correction is to be performed. If a bias correction is to be performed, a collection of touchpoints and associated contribution values corresponding to a certain site can be identified (see operation 720). The collection of touchpoints can be analyzed (e.g., compared) to identify the low or lowest performing touchpoint contribution value(s) from the selected set of touchpoints for the site (see operation 722). Corrected contribution values and ranges for the collection of touchpoints associated with the site can then be generated (see operation 724). In one or more embodiments, a corrected contribution value can be generated by subtracting the low performing touchpoint contribution value of the site from the uncorrected contribution values associated with the remaining touchpoints in the site. A decision 726 determines if more sites are to be identified for bias correction. If one or more sites are to be identified for bias correction, the process returns to operation 720 and continues until all sites have been processed.

### Additional Practical Application Examples

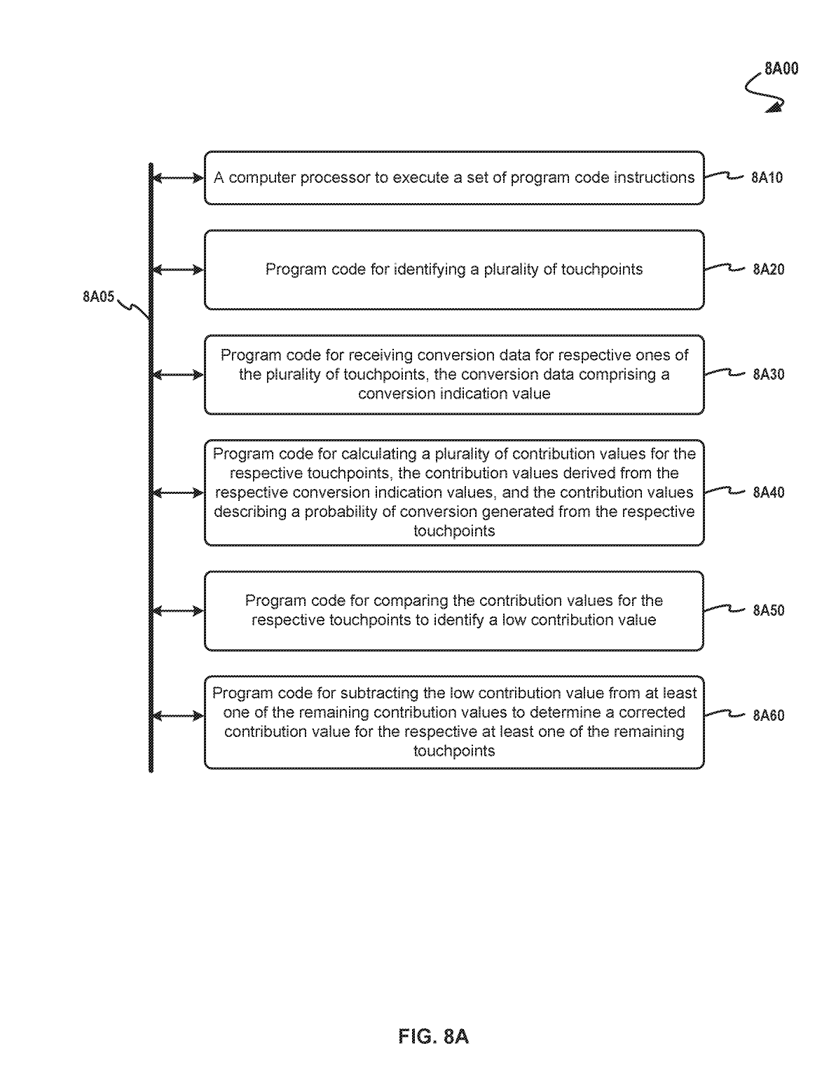

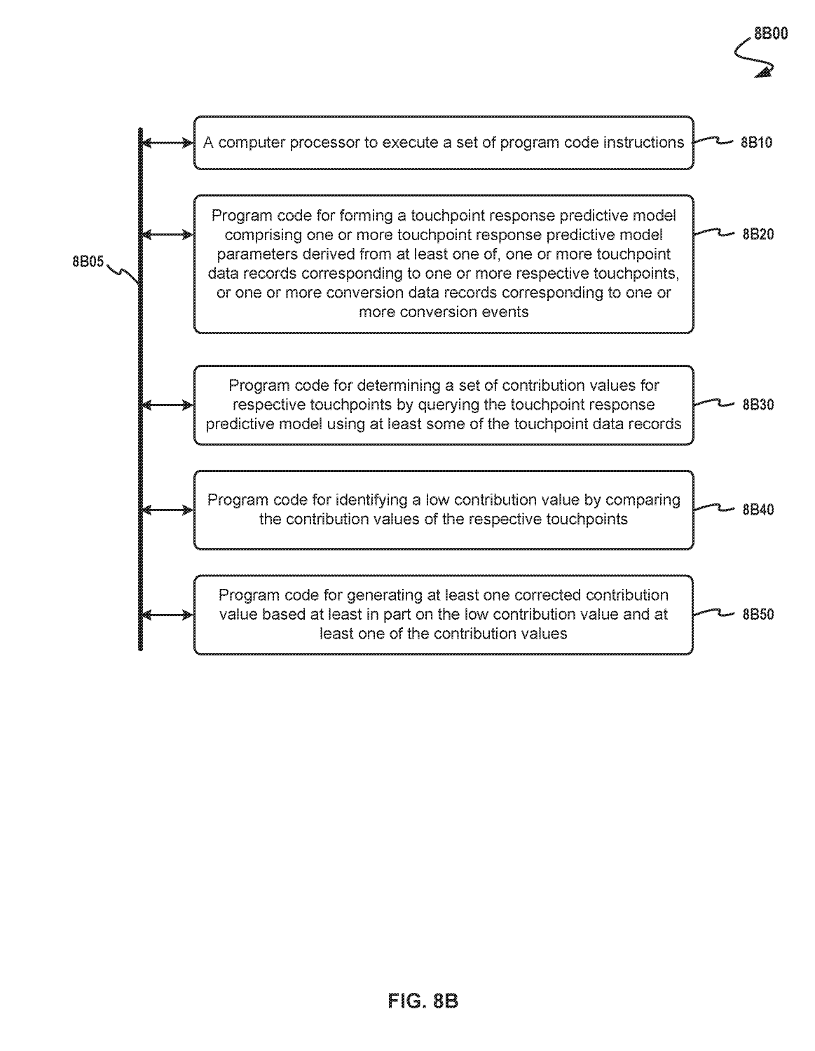

FIG. 8A is a block diagram of a system 8A00 for marketing touchpoint attribution bias correction. As shown, system 8A00 comprises at least one processor and at least one memory, the memory serving to store program instructions corresponding to the operations of the system.

As shown, an operation can be implemented in whole or in part using program instructions accessible by a module. The modules are connected to a communication path 8A05, and any operation can communicate with other operations over communication path 8A05. The modules of the system can, individually or in combination, perform method operations within system 8A00. Any operations performed within system 8A00 may be performed in any order unless as may be specified in the claims. The embodiment of FIG. 8A implements a portion of a computer system, shown as system 8A00, comprising a computer processor to execute a set of program code instructions (see module 8A10) and modules for accessing memory to hold program code instructions to perform: identifying a plurality of touchpoints (see module 8A20); receiving conversion data for respective ones of the plurality of touchpoints, the conversion data comprising a conversion indication value (see module 8A30); calculating a plurality of contribution values for the respective touchpoints, the contribution values derived at least in part from the respective conversion indication values and at least in part from the contribution values describing a probability of conversion generated from the respective touchpoints (see module 8A40); comparing the contribution values for the respective touchpoints to identify a low contribution value (see module 8A50); and subtracting the low contribution value from at least one of the remaining contribution values to determine a corrected contribution value for the respective at least one of the remaining touchpoints (see module 8A60).

FIG. 8B is a block diagram of a system 8B00 for marketing touchpoint attribution bias correction. As an option, the present system 8B00 may be implemented in the context of the architecture and functionality of the embodiments described herein. Of course, however, the system 8B00 or any operation therein may be carried out in any desired environment. The system 8B00 comprises at least one processor and at least one memory, the memory serving to store program instructions corresponding to the operations of the system. As shown, an operation can be implemented in whole or in part using program instructions accessible by a module. The modules are connected to a communication path 8B05, and any operation can communicate with other operations over communication path 8B05. The modules of the system can, individually or in combination, perform method operations within system 8B00. Any operations performed within system 8B00 may be performed in any order unless as may be specified in the claims. The shown embodiment implements a portion of a computer system, presented as system 8B00, comprising a computer processor to execute a set of program code instructions (see module 8B10) and modules for accessing memory to hold program code instructions to perform: forming a touchpoint response predictive model comprising one or more touchpoint response predictive model parameters derived from at least one of, one or more touchpoint data records corresponding to one or more respective touchpoints, or one or more conversion data records corresponding to one or more conversion events (see module 8B20); determining a set of contribution values for respective touchpoints by querying the touchpoint response predictive model using at least some of the touchpoint data records (see module 8B30); identifying a low contribution value by comparing the contribution values of the respective touchpoints (see module 8B40); and generating at least one corrected contribution value based at least in part on the low contribution value and at least one of the contribution values (see module 8B50).

Some embodiments process data using machine learning techniques to generate the predictive models. Strictly as an example, some embodiments process the touchpoint encounters that represent marketing messages exposed to a plurality of users by sorting the data for the touchpoint encounters so as to separate into sets of converting user data, which comprises (1) sets of touchpoint encounters for users that exhibited a positive response to the marketing message, and (2) sets of touchpoint encounters or other user data that comprises non-converting user data (e.g., pertaining to touchpoint encounters for users that exhibited a negative response to the marketing message). The converting user data and the non-converting user data is used for training a model (e.g., using machine-learning techniques). The model comprising converting user data and non-converting user data can be used to determine a set of contribution values for each of the touchpoints (e.g., where the contribution values for a touchpoint reflect importance of the respective touchpoint, relative to other touchpoints vis-à-vis a measured response of the marketing message). Accessing the model, and/or its constituent data (or other access techniques) can be used to identify a low contribution value by comparing the contribution values of the respective touchpoints. Corrected remaining contribution values can be calculated by subtracting the low contribution value from the remaining contribution values.

### Additional System Architecture Examples

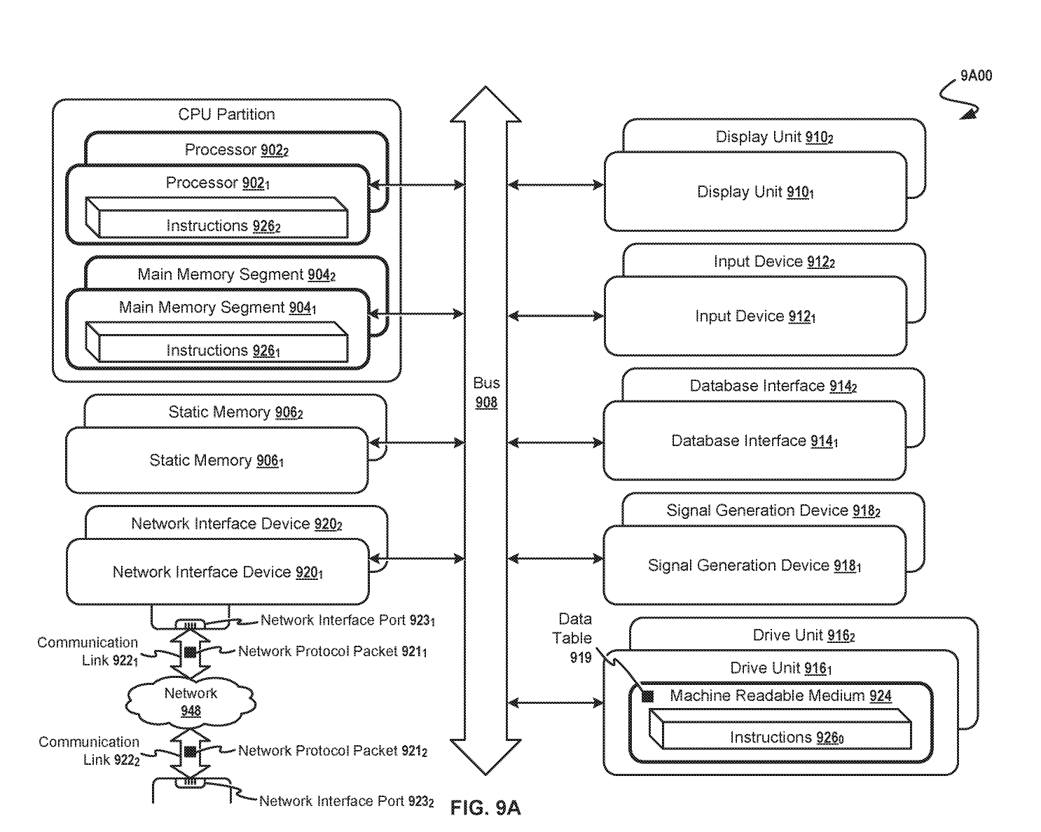

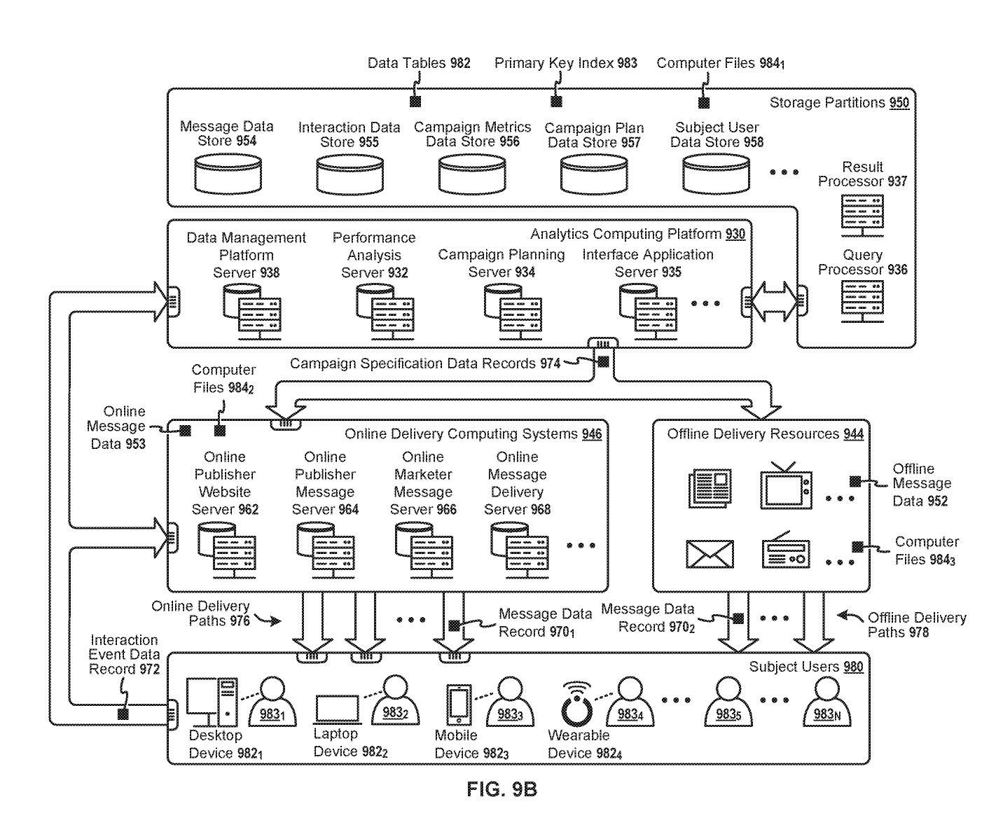

FIG. 9A depicts a diagrammatic representation of a machine in the exemplary form of a computer system 9A00 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 9A00 includes one or more processors (e.g., processor 902₁, processor 902₂, etc.), a main memory comprising one or more main memory segments (e.g., main memory segment 9041, main memory segment 904₂, etc.), one or more static memories (e.g., static memory 906₁, static memory 906₂, etc.), which communicate with each other via a bus 908. The computer system 9A00 may further include one or more video display units (e.g., display unit 910₁, display unit 910₂, etc.), such as an LED display, or a liquid crystal display (LCD), or a cathode ray tube (CRT). The computer system 9A00 can also include one or more input devices (e.g., input device 912₁, input device 912₂, alphanumeric input device, keyboard, pointing device, mouse, etc.), one or more database interfaces (e.g., database interface 914₁, database interface 914₂, etc.), one or more disk drive units (e.g., drive unit 916₁, drive unit 916₂, etc.), one or more signal generation devices (e.g., signal generation device 918₁, signal generation device 918₂, etc.), and one or more network interface devices (e.g., network interface device 920₁, network interface device 920₂, etc.).

The disk drive units can include one or more instances of a machine-readable medium 924 on which is stored one or more instances of a data table 919 to store electronic information records. The machine-readable medium 924 can further store a set of instructions 926₀ (e.g., software) embodying any one, or all, of the methodologies described above. A set of instructions 926₁ can also be stored within the main memory (e.g., in main memory segment 904₁). Further, a set of instructions 926₂ can also be stored within the one or more processors (e.g., processor 9021). Such instructions and/or electronic information may further be transmitted or received via the network interface devices at one or more network interface ports (e.g., network interface port 9231, network interface port 923₂, etc.). Specifically, the network interface devices can communicate electronic information across a network using one or more optical links, Ethernet links, wireline links, wireless links, and/or other electronic communication links (e.g., communication link 922₁, communication link 922₂, etc.). One or more network protocol packets (e.g., network protocol packet 921₁, network protocol packet 921₂, etc.) can be used to hold the electronic information (e.g., electronic data records) for transmission across an electronic communications network (e.g., network 948). In some embodiments, the network 948 may include, without limitation, the web (i.e., the Internet), one or more local area networks (LANs), one or more wide area networks (WANs), one or more wireless networks, and/or one or more cellular networks.

The computer system 9A00 can be used to implement a client system and/or a server system, and/or any portion of network infrastructure.

It is to be understood that various embodiments may be used as or to support software programs executed upon some form of processing core (such as the CPU of a computer) or otherwise implemented or realized upon or within a machine or computer readable medium. A machine-readable medium includes any mechanism for storing or transmitting information in a form readable by a machine (e.g., a computer). For example, a machine-readable medium includes read-only memory (ROM); random access memory (RAM); magnetic disk storage media; optical storage media; flash memory devices; or any other type of non-transitory media suitable for storing or transmitting information.

A module as used herein can be implemented using any mix of any portions of the system memory, and any extent of hard-wired circuitry including hard-wired circuitry embodied as one or more processors (e.g., processor 902₁, processor 902₂, etc.).

FIG. 9B depicts a block diagram of a data processing system suitable for implementing instances of the herein-disclosed embodiments. The data processing system may include many more or fewer components than those shown.

The components of the data processing system may communicate electronic information (e.g., electronic data records) across various instances and/or types of an electronic communications network (e.g., network 948) using one or more electronic communication links (e.g., communication link 922₁, communication link 922₂, etc.). Such communication links may further use supporting hardware, such as modems, bridges, routers, switches, wireless antennas and towers, and/or other supporting hardware. The various communication links transmit signals comprising data and commands (e.g., electronic data records) exchanged by the components of the data processing system, as well as any supporting hardware devices used to transmit the signals. In some embodiments, such signals are transmitted and received by the components at one or more network interface ports (e.g., network interface port 923₁, network interface port 923₂, etc.). In one or more embodiments, one or more network protocol packets (e.g., network protocol packet 921₁, network protocol packet 921₂, etc.) can be used to hold the electronic information comprising the signals.

As shown, the data processing system can be used by one or more advertisers to target a set of subject users 980 (e.g., user 983₁, user 983₂, user 983₃, user 983₄, user 983₅, to user 983_{N}) in various marketing campaigns. The data processing system can further be used to determine, by an analytics computing platform 930, various characteristics (e.g., performance metrics, etc.) of such marketing campaigns. Other operations, transactions, and/or activities associated with the data processing system are possible. Specifically, the subject users 980 can receive a plurality of online message data 953 transmitted through any of a plurality of online delivery paths 976 (e.g., online display, search, mobile ads, etc.) to various computing devices (e.g., desktop device 982₁, laptop device 982₂, mobile device 982₃, and wearable device 982₄). The subject users 980 can further receive a plurality of offline message data 952 presented through any of a plurality of offline delivery paths 978 (e.g., TV, radio, print, direct mail, etc.). The online message data 953 and/or the offline message data 952 can be selected for delivery to the subject users 980 based in part on certain instances of campaign specification data records 974 (e.g., established by the advertisers and/or the analytics computing platform 930). For example, the campaign specification data records 974 might comprise settings, rules, taxonomies, and other information transmitted electronically to one or more instances of online delivery computing systems 946 and/or one or more instances of offline delivery resources 944. The online delivery computing systems 946 and/or the offline delivery resources 944 can receive and store such electronic information in the form of instances of computer files 984₂ and computer files 984₃, respectively. In one or more embodiments, the online delivery computing systems 946 can comprise computing resources such as an online publisher website server 962, an online publisher message server 964, an online marketer message server 966, an online message delivery server 968, and other computing resources. For example, the message data record 9701 presented to the subject users 980 through the online delivery paths 976 can be transmitted through the communications links of the data processing system as instances of electronic data records using various protocols (e.g., HTTP, HTTPS, etc.) and structures (e.g., JSON), and rendered on the computing devices in various forms (e.g., digital picture, hyperlink, advertising tag, text message, email message, etc.). The message data record 970₂ presented to the subject users 980 through the offline delivery paths 978 can be transmitted as sensory signals in various forms (e.g., printed pictures and text, video, audio, etc.).

The analytics computing platform 930 can receive instances of an interaction event data record 972 comprising certain characteristics and attributes of the response of the subject users 980 to the message data record 970₁, the message data record 970₂, and/or other received messages. For example, the interaction event data record 972 can describe certain online actions taken by the users on the computing devices, such as visiting a certain URL, clicking a certain link, loading a web page that fires a certain advertising tag, completing an online purchase, and other actions. The interaction event data record 972 may also include information pertaining to certain offline actions taken by the users, such as purchasing a product in a retail store, using a printed coupon, dialing a toll-free number, and other actions. The interaction event data record 972 can be transmitted to the analytics computing platform 930 across the communications links as instances of electronic data records using various protocols and structures. The interaction event data record 972 can further comprise data (e.g., user identifier, computing device identifiers, timestamps, IP addresses, etc.) related to the users and/or the users' actions.

The interaction event data record 972 and other data generated and used by the analytics computing platform 930 can be stored in one or more storage partitions 950 (e.g., message data store 954, interaction data store 955, campaign metrics data store 956, campaign plan data store 957, subject user data store 958, etc.). The storage partitions 950 can comprise one or more databases and/or other types of non-volatile storage facilities to store data in various formats and structures (e.g., data tables 982, computer files 984₁, etc.). The data stored in the storage partitions 950 can be made accessible to the analytics computing platform 930 by a query processor 936 and a result processor 937, which can use various means for accessing and presenting the data, such as a primary key index 983 and/or other means. In one or more embodiments, the analytics computing platform 930 can comprise a performance analysis server 932 and a campaign planning server 934. Operations performed by the performance analysis server 932 and the campaign planning server 934 can vary widely by embodiment. As an example, the performance analysis server 932 can be used to analyze the messages presented to the users (e.g., message data record 970₁ and message data record 970₂) and the associated instances of the interaction event data record 972 to determine various performance metrics associated with a marketing campaign, which metrics can be stored in the campaign metrics data store 956 and/or used to generate various instances of the campaign specification data records 974. Further, for example, the campaign planning server 934 can be used to generate marketing campaign plans and associated marketing spend apportionments, which information can be stored in the campaign plan data store 957 and/or used to generate various instances of the campaign specification data records 974. Certain portions of the interaction event data record 972 might further be used by a data management platform server 938 in the analytics computing platform 930 to determine various user attributes (e.g., behaviors, intent, demographics, device usage, etc.), which attributes can be stored in the subject user data store 958 and/or used to generate various instances of the campaign specification data records 974. One or more instances of an interface application server 935 can execute various software applications that can manage and/or interact with the operations, transactions, data, and/or activities associated with the analytics computing platform 930. For example, a marketing manager might interface with the interface application server 935 to view the performance of a marketing campaign and/or to allocate media spend for another marketing campaign.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are, accordingly, to be regarded in an illustrative sense rather than in a restrictive sense.

What is claimed is:

1. A computer implemented method for allocating credit for conversions among advertising touchpoints, the computer implemented method comprising:
storing in a computer, a plurality of touchpoint encounters that represent marketing messages exposed to a plurality of users;
sorting data for the touchpoint encounters in the computer to separate into converting user data, which comprises touchpoint encounters for users that exhibited a positive response to the marketing message, and non-converting user data that comprises touchpoint encounters for users that exhibited a negative response to the marketing message;
retrieving, from storage, the converting user data and the non-converting user data;
training, using machine-learning techniques in a computer, the converting user data and the non-converting user data as training data to determine a set of contribution values for each of the touchpoints, wherein the contribution values for a touchpoint reflect importance of the respective touchpoint, relative to other touchpoints, to the response of the marketing message;
identifying a low contribution value by comparing the contribution values of the respective touchpoints; and
generating at least one corrected contribution value based at least in part on the low contribution value and at least one of the contribution values.

2. The method of claim 1, wherein the contribution values characterize a measure of an influence attributed to the respective touchpoints in transitioning at least one user from a first engagement state to a second engagement state.

3. The method of claim 1, wherein generating the corrected contribution value comprises subtracting the low contribution value from at least one of the contribution values.

4. The method of claim 1, further comprising generating one or more touchpoint combination contribution values by combining two or more contribution values.

5. The method of claim 4, further comprising generating at least one corrected touchpoint combination contribution value based at least in part on the low contribution value and at least one of the touchpoint combination contribution values.

6. The method of claim 5, wherein generating the corrected touchpoint combination contribution value comprises subtracting the low contribution value from at least one of the touchpoint combination contribution values.

7. The method of claim 1, further comprising generating at least one contribution value range based at least in part on the corrected contribution value and at least one of the contribution values.

8. The method of claim 1, further comprising generating at least one additional corrected contribution value based at least in part on the low contribution value and one or more contribution values associated with one or more respective additional touchpoints.

9. The method of claim 1, wherein the respective touchpoints are associated with an engagement stack.

10. The method of claim 1, wherein the respective touchpoints are associated with a common touchpoint attribute.

11. The method of claim 1, wherein the respective touchpoints are associated with a common desired response.

12. The method of claim 1, wherein the respective touchpoints are associated with a set of common audience demographics.

13. A computer program, embodied in a non-transitory computer readable medium, the non-transitory computer readable medium having stored thereon a sequence of instructions which, when stored in memory and executed by a processor causes the processor to perform a set of acts, the acts comprising:
storing in a computer, a plurality of touchpoint encounters that represent marketing messages exposed to a plurality of users;
sorting data for the touchpoint encounters in the computer to separate into converting user data, which comprises touchpoint encounters for users that exhibited a positive response to the marketing message, and non-converting user data that comprises touchpoint encounters for users that exhibited a negative response to the marketing message;
retrieving, from storage, the converting user data and the non-converting user data;
training, using machine-learning techniques in a computer, the converting user data and the non-converting user data as training data to determine a set of contribution values for each of the touchpoints, wherein the contribution values for a touchpoint reflect importance of the respective touchpoint, relative to other touchpoints, to the response of the marketing message;
identifying a low contribution value by comparing the contribution values of the respective touchpoints; and
generating at least one corrected contribution value based at least in part on the low contribution value and at least one of the contribution values.

14. The computer readable medium of claim 13, wherein the contribution values characterize a measure of an influence attributed to the respective touchpoints in transitioning at least one user from a first engagement state to a second engagement state.

15. The computer readable medium of claim 13, wherein generating the corrected contribution value comprises subtracting the low contribution value from at least one of the contribution values.

16. The computer readable medium of claim 13, further comprising instructions which, when stored in memory and executed by a processor causes the processor to perform generating one or more touchpoint combination contribution values by combining two or more contribution values.

17. The computer readable medium of claim 16, further comprising instructions which, when stored in memory and executed by a processor causes the processor to perform generating at least one corrected touchpoint combination contribution value based at least in part on the low contribution value and at least one of the touchpoint combination contribution values.

18. The computer readable medium of claim 17, wherein generating the corrected touchpoint combination contribution value comprises subtracting the low contribution value from at least one of the touchpoint combination contribution values.

19. As system comprising:
a storage device to store in a computer, a plurality of touchpoint encounters that represent marketing messages exposed to a plurality of users; and
a processor for executing instructions which, when stored in a memory and executed by the processor causes the processor to perform,
sorting data for the touchpoint encounters to separate into converting user data, which comprises touchpoint encounters for users that exhibited a positive response to the marketing message, and non-converting user data that comprises touchpoint encounters for users that exhibited a negative response to the marketing message;
retrieving, from storage, the converting user data and the non-converting user data;
training, using machine-learning techniques in a computer, the converting user data and the non-converting user data as training data to determine a set of contribution values for each of the touchpoints, wherein the contribution values for a touchpoint reflect importance of the respective touchpoint, relative to other touchpoints, to the response of the marketing message;
identifying a low contribution value by comparing the contribution values of the respective touchpoints; and
generating at least one corrected contribution value based at least in part on the low contribution value and at least one of the contribution values.

20. The system of claim 19, wherein the contribution values characterize a measure of an influence attributed to the respective touchpoints in transitioning at least one user from a first engagement state to a second engagement state.
